(19) United States
(12) Patent Application Publication
(10) Pub. No.: US 2026/0010105 A1
(43) Pub. Date: Jan. 8, 2026

(54) IMAGE FORMING SYSTEM

(71) Applicant: FUJIFILM Business Innovation Corp., Tokyo (JP)

(72) Inventors: Yusuke TAIRA, Kanagawa (JP); Minoru SAKAMOTO, Kanagawa (JP)

(73) Assignee: FUJIFILM Business Innovation Corp., Tokyo (JP)

(21) Appl. No.: 19/049,088

(22) Filed: Feb. 10, 2025

(30) Foreign Application Priority Data
Jul. 4, 2024 (JP) 2024-108412

(51) Int. Cl. G03G 15/00; G03G 15/043

(52) U.S. Cl. CPC G03G 15/5054; G03G 15/043

(57) ABSTRACT

An image forming system includes: an image bearing member that rotates; an exposure device that is disposed facing the image bearing member, has multiple lenses arranged in an axial direction of the image bearing member, and exposes the image bearing member to light; a developing device that develops an electrostatic latent image formed on the image bearing member by the exposure device into a toner image; a detector that detects an image density of the toner image; an adjustment device that adjusts a distance between the image bearing member and the exposure device; and at least one processor configured to cause the adjustment device to adjust the distance when the image density detected by the detector reaches a predetermined threshold value.

### CROSS-REFERENCE TO RELATED APPLICATIONS

This application is based on and claims priority under 35 USC 119 from Japanese Patent Application No. 2024-108412 filed Jul. 4, 2024.

### BACKGROUND

### (i) Technical Field

The present disclosure relates to image forming systems.

### (ii) Related Art

An LED-print-head (LPH) focal-point adjustment method according to Japanese Unexamined Patent Application Publication No. 2008-73867 involves setting a first longitudinal end of the LPH to a first negative (−) position where the distance between a photoconductor drum and the LPH is shorter than a designed focal-point distance, and setting a second longitudinal end of the LPH to a second positive (+) position where the distance is longer than the designed focal-point distance. Subsequently, a predetermined pattern image that enables determination of resolution is output onto recording paper, and the position of the LPH is adjusted to a position with high resolution based on information about the resolution of the output pattern image.

### SUMMARY

Aspects of non-limiting embodiments of the present disclosure relate to adjusting the distance between an image bearing member and an exposure device when the distance between the image bearing member and the exposure device changes.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an image forming system including: an image bearing member that rotates; an exposure device that is disposed facing the image bearing member, has multiple lenses arranged in an axial direction of the image bearing member, and exposes the image bearing member to light; a developing device that develops an electrostatic latent image formed on the image bearing member by the exposure device into a toner image; a detector that detects an image density of the toner image; an adjustment device that adjusts a distance between the image bearing member and the exposure device; and at least one processor configured to cause the adjustment device to adjust the distance when the image density detected by the detector reaches a predetermined threshold value.

### BRIEF DESCRIPTION OF THE DRAWINGS

An exemplary embodiment of the present disclosure will be described in detail based on the following figures, wherein:

FIG. 1 schematically illustrates the configuration of an image forming system according to an exemplary embodiment of the present disclosure;

FIG. 2 schematically illustrates the configuration of an image forming unit included in the image forming system according to the exemplary embodiment of the present disclosure;

FIG. 3 is an exploded perspective view illustrating an exposure device included in the image forming system according to the exemplary embodiment of the present disclosure;

FIG. 4 is a perspective view illustrating the exposure device included in the image forming system according to the exemplary embodiment of the present disclosure;

FIG. 5 is a cross-sectional view illustrating the exposure device included in the image forming system according to the exemplary embodiment of the present disclosure;

FIG. 6 is a side view illustrating, for example, an image bearing member and the exposure device included in the image forming system according to the exemplary embodiment of the present disclosure;

FIG. 7 is a front view illustrating a detection sensor and a part of a transfer belt included in the image forming system according to the exemplary embodiment of the present disclosure;

FIG. 8 is a perspective view illustrating the detection sensor and the part of the transfer belt included in the image forming system according to the exemplary embodiment of the present disclosure;

FIGS. 9A and 9B are block diagrams respectively illustrating a hardware configuration and a functional configuration of a controller provided in the image forming system according to the exemplary embodiment of the present disclosure;

FIG. 10 is a graph illustrating the relationship between the distance between the exposure device and the image bearing member and the image density of each predetermined patch image in the image forming system according to the exemplary embodiment of the present disclosure; and

FIG. 11 is a flowchart illustrating a process for adjusting the distance between the image bearing member and the exposure device in the image forming system according to the exemplary embodiment of the present disclosure.

### DETAILED DESCRIPTION

### First Exemplary Embodiment

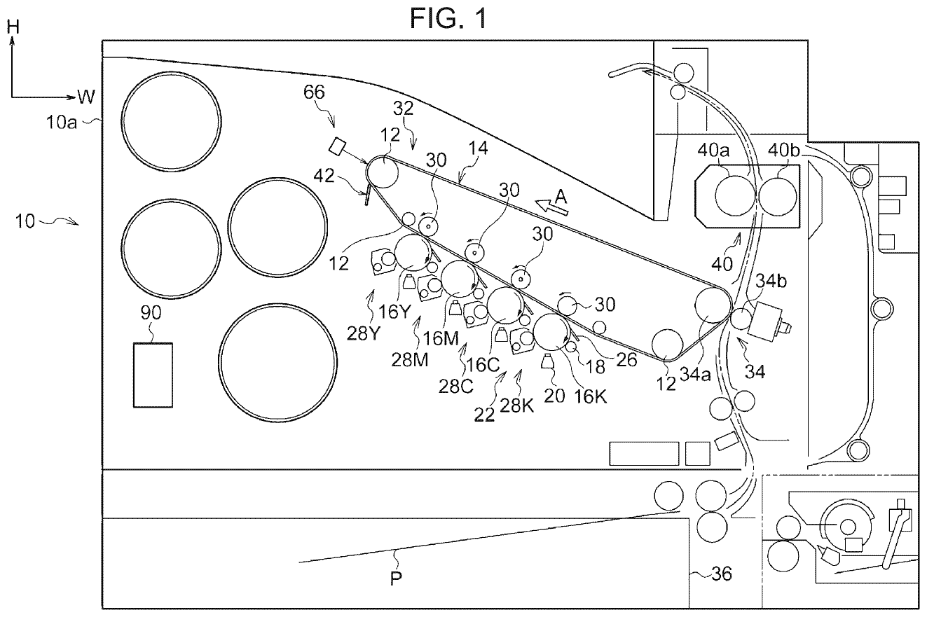

An example of an image forming system according to an exemplary embodiment of the present disclosure will now be described with reference to FIGS. 1 to 11. An arrow H shown in each drawing denotes the vertical direction and indicates an up-down direction of a device or apparatus. An arrow W denotes the horizontal direction orthogonal to the arrow H, and indicates a width direction of the device or apparatus. An arrow D denotes the horizontal direction orthogonal to the arrow H and the arrow W, and indicates a depth direction of the device or apparatus.

### Overall Configuration of Image Forming System 10

As shown in FIG. 1, an apparatus body 10a of an image forming system 10 is provided with an endless transfer belt 14 included in a transfer unit 32. The transfer belt 14 is stretched among multiple rollers 12 and is transported in the direction of the arrow A by being driven by a motor (not shown). Furthermore, the image forming system 10 includes a controller 90 that controls each unit.

The image forming system 10 corresponds with color-image formation. In the image forming system 10, image forming units 28Y, 28M, 28C, and 28K that form toner images corresponding to four colors, namely, yellow (Y), magenta (M), cyan (C), and black (K) colors, are arranged in the longitudinal direction of the transfer belt 14 and are detachably supported by the apparatus body 10a.

Components provided for the respective colors will be indicated by being given alphabetical characters (Y/M/C/K) to the suffixes of the reference signs to indicate the respective colors. However, if the colors are not to be particularly differentiated from one another, the alphabetical characters at the suffixes will be omitted.

### Image Forming Units 28

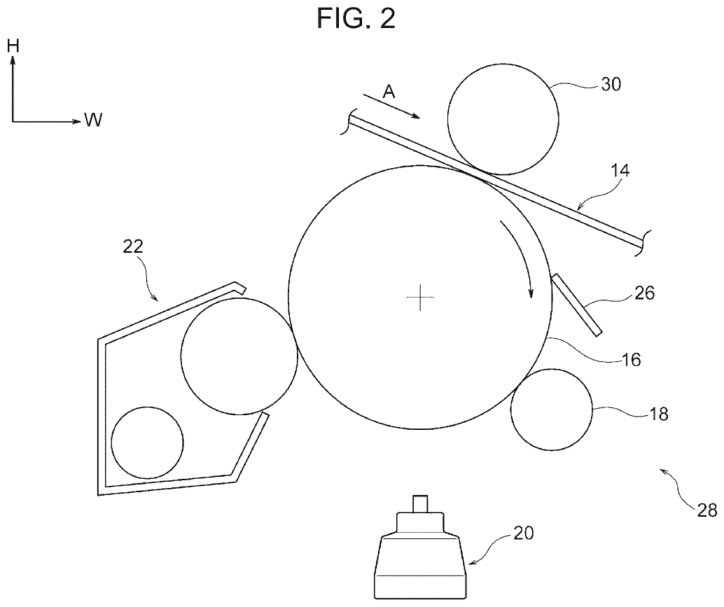

As shown in FIGS. 1 and 2, each image forming unit 28 includes an image bearing member 16 that rotates clockwise. Furthermore, a charging roller 18 that electrostatically charges the surface of the image bearing member 16 uniformly to a predetermined potential is disposed on the peripheral surface of the image bearing member 16. Moreover, at the peripheral surface located downstream of the charging roller 18 in the rotational direction of the image bearing member 16, an exposure device 20 that forms an electrostatic latent image by radiating exposure light onto the image bearing member 16 is disposed to extend in the axial direction of the image bearing member 16. The exposure device 20 will be described in detail later.

A developing device 22 is disposed on the peripheral surface located downstream of the exposure device 20 in the rotational direction of the image bearing member 16. The developing device 22 uses a toner of the corresponding color to develop the electrostatic latent image formed on the image bearing member 16, thereby forming a toner image. A cleaning blade 26 that collects the toner remaining on the image bearing member 16 is disposed on the peripheral surface located downstream of a transfer roller 30, to be described later, in the rotational direction of the image bearing member 16.

### Transfer Unit 32

As shown in FIG. 1, the transfer unit 32 includes the transfer rollers 30 disposed opposite the image bearing members 16 with the transfer belt 14 interposed therebetween. The transfer rollers 30 transfer the toner images on the image bearing members 16 onto the transfer belt 14.

Furthermore, a transfer device 34 including two opposing rollers 34a and 34b is disposed downstream of the image bearing members 16 for the respective colors in the revolving direction of the transfer belt 14. A final toner image formed on the transfer belt 14 is transferred onto a sheet P that is fetched from a sheet tray 36 provided at the bottom of the image forming system 10 and that is transported between the rollers 34a and 34b.

A collecting blade 42 that collects the toner remaining on the transfer belt 14 is provided downstream of the transfer device 34 in the revolving direction of the transfer belt 14.

### Fixing Device 40

As shown in FIG. 1, a fixing device 40 is disposed in a transport path of the sheet P having the toner image transferred thereon. The fixing device 40 includes a heating roller 40a and a pressing roller 40b. The sheet P is nipped and transported by the heating roller 40a and the pressing roller 40b, so that the toner of the toner image on the sheet P is fused and pressure-bonded onto the sheet P and becomes fixed to the sheet P.

### Controller 90

The controller 90 controls each unit to form a toner image onto the sheet P. The configuration and the operation of the controller 90 when adjusting the distance between each image bearing member 16 and each exposure device 20 will be described in detail later.

### Operation of Overall Configuration

In the image forming system 10, an image is formed as follows.

First, each charging roller 18 shown in FIG. 1 electrostatically charges the surface of the corresponding image bearing member 16 uniformly to a negative potential. The corresponding exposure device 20 performs exposure by outputting exposure light such that an image area on the electrostatically-charged image bearing member 16 is set to a predetermined exposure potential, whereby an electrostatic latent image is formed on the image bearing member 16. When the electrostatic latent image on the image bearing member 16 passes the developing device 22, the electrostatic latent image becomes developed into a toner image, thereby becoming visualized.

The visualized toner images are sequentially transferred onto the transfer belt 14 by an electrostatic force of the transfer rollers 30, so that a final color toner image is formed on the transfer belt 14.

The final toner image is fed into between the rollers 34a and 34b provided in the transfer device 34. Then, the final toner image is transferred onto the sheet P fetched from the sheet tray 36 and transported between the rollers 34a and 34b. Moreover, the toner image transferred on the sheet P is fixed onto the sheet P by the fixing device 40, and the sheet P is discharged outward from the apparatus body 10a.

### Relevant Components

Next, for example, the exposure devices 20, a detection sensor 66 that detects the image density of the toner image transferred on the transfer belt 14, and the controller 90 will be described.

### Exposure Devices 20

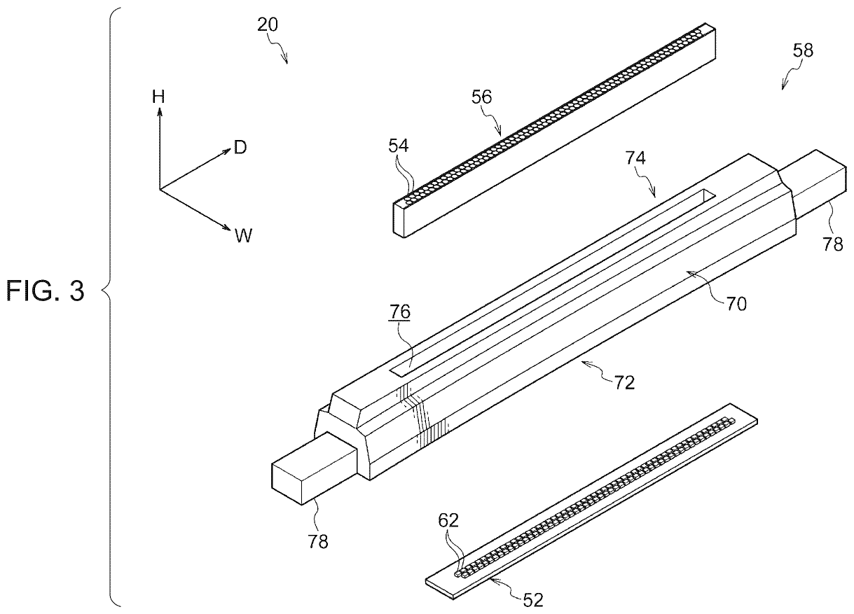

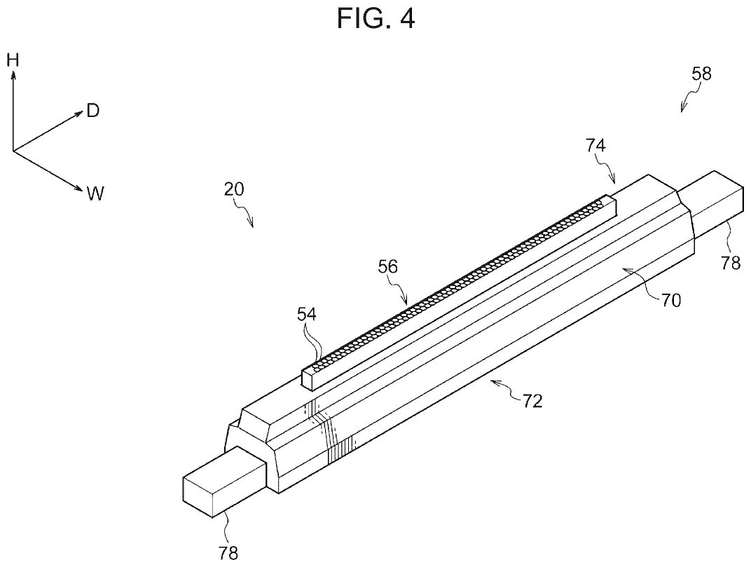

Each exposure device 20 shown in FIG. 1 is a light-emitting-diode (LED) print head having a long shape extending in the depth direction. As shown in FIGS. 3 and 4, the exposure device 20 includes a substrate 52 as a printed wiring substrate having light-emitting-diode (LED) arrays 62 mounted thereon as electronic components. Each LED array 62 is an example of a light emitting element.

The exposure device 20 includes a lens array 56 extending in the depth direction and having multiple cylindrical rod lenses 54 that are arranged in the depth direction and through which light emitted from light emitting points of the LED arrays 62 is transmitted. The exposure device 20 also includes a housing 58 to which the substrate 52 and the lens array 56 are attached. The depth direction is an example of an axial direction, and the rod lenses 54 are an example of lenses.

### Substrate 52

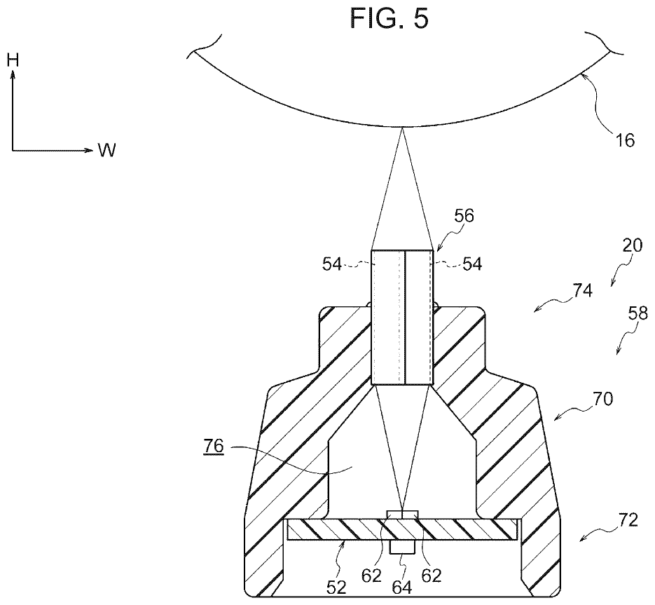

As shown in FIG. 3, the substrate 52 extends in the depth direction, has the thickness direction of the substrate 52 as the up-down direction, and is rectangular as viewed in the thickness direction. Light-emitting-diode (LED) arrays 62 each having multiple linearly-provided LEDs are mounted in a staggered pattern on the upper surface of the substrate 52. In contrast, an electronic component 64 (see FIG. 5) that controls the LED arrays 62 are mounted on the other surface of the substrate 52.

### Lens Array 56

As shown in FIGS. 3 and 4, the lens array 56 has a rectangular parallelepiped shape extending in the depth direction. The lens array 56 has the multiple rod lenses 54 that are arranged in a staggered pattern and through which the light output from the LED arrays 62 is transmitted. Accordingly, the light output from the LED arrays 62 and transmitted through the rod lenses 54 forms an image on the image bearing member 16 (see FIG. 5).

### Housing 58

The housing 58 is molded by using a resin material, such as a liquid crystal polymer, and extends in the depth direction, as shown in FIGS. 3 and 4. A cross section of the housing 58 intersecting the depth direction is symmetrical in the width direction, as shown in FIG. 5.

As shown in FIGS. 3 and 4, the housing 58 has a through-hole 76 extending in the depth direction and extending through the housing 58 in the up-down direction.

As shown in FIG. 5, in the housing 58, an upper end in the up-down direction is provided with a lens fixation section 74 where the lens array 56 is fixed, a lower end in the up-down direction is provided with a substrate fixation section 72 where the substrate 52 is fixed, and a body section 70 is provided between the substrate fixation section 72 and the lens fixation section 74. The lens array 56 is fixed to an upper end of the through-hole 76, and the substrate 52 is fixed to a lower end of the through-hole 76. Accordingly, the rod lenses 54 of the lens array 56 and the LED arrays 62 mounted on the substrate 52 face each other in the up-down direction.

As shown in FIGS. 3 and 4, the housing 58 includes protrusions 78 protruding in the depth direction from the body section 70 and the substrate fixation section 72. In detail, each protrusion 78 has a cross-sectionally rectangular shape extending in the depth direction.

A support structure for the exposure device 20 will now be described.

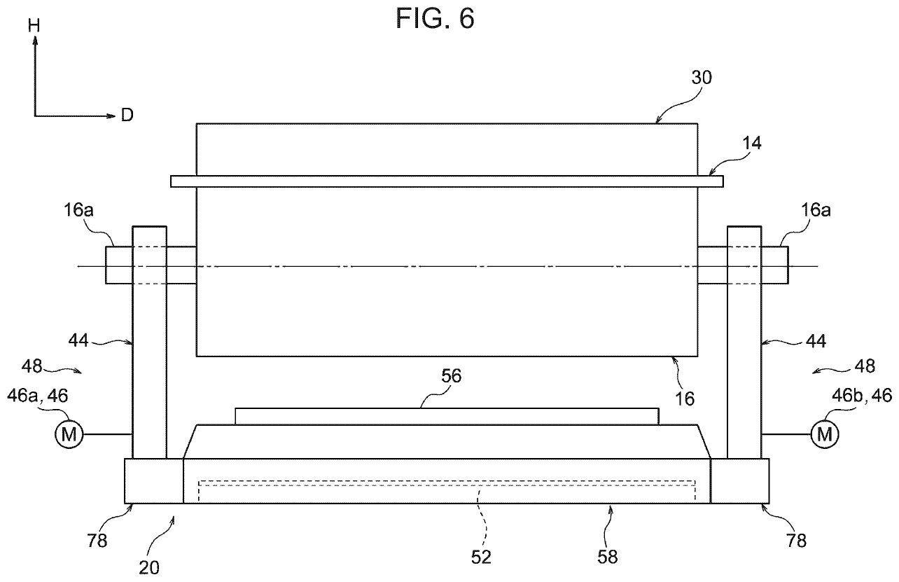

As shown in FIG. 6, the exposure device 20 is disposed to face the image bearing member 16 in the up-down direction, and is positioned relative to the image bearing member 16 in the up-down direction via a rotation shaft 16a of the image bearing member 16.

In detail, a pair of adjustment blocks 44 extending in the up-down direction are provided and are disposed at opposite ends of the image bearing member 16. The protrusions 78 provided at the housing 58 of the exposure device 20 are attached to lower ends of the adjustment blocks 44. Moreover, upper ends of the adjustment blocks 44 rotatably support the rotation shaft 16a of the image bearing member 16.

Each adjustment block 44 includes a rack-and-pinion mechanical member. A stepping motor 46 (referred to as “motor 46” hereinafter) that applies a rotational force to the mechanism member of the adjustment block 44 is provided. For the sake of convenience, in the following description, the motor 46 at the near side in the depth direction will be referred to as a motor 46a, whereas the motor 46 at the far side in the depth direction will be referred to as a motor 46b.

In this configuration, the motors 46 rotate so that the mechanical members provided in the adjustment blocks 44 are actuated, thereby causing the exposure device 20 to move toward and away from the image bearing member 16. Specifically, when the motor 46a at the near side in the depth direction is rotated, the portion of the exposure device 20 at the near side in the depth direction moves toward and away from the image bearing member 16. In contrast, when the motor 46b at the far side in the depth direction is rotated, the portion of the exposure device 20 at the far side in the depth direction moves toward and away from the image bearing member 16.

Accordingly, an adjustment device 48 provided includes the motors 46 and the adjustment blocks 44 and adjusts the distance between the image bearing member 16 and the exposure device 20.

### Detection Sensor 66

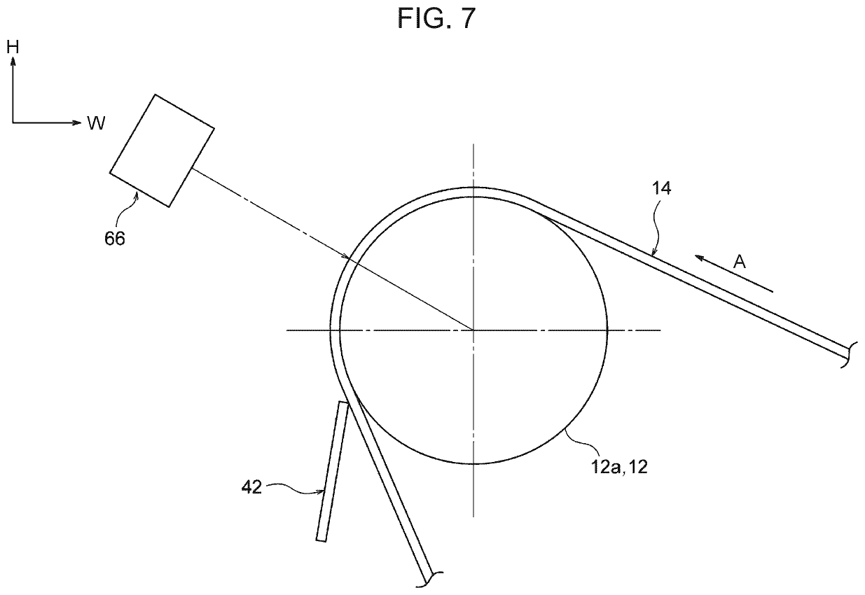

The detection sensor 66 is an optical sensor that detects the image density of the toner image transferred on the transfer belt 14. As shown in FIG. 7, the detection sensor 66 is disposed to face an area of the transfer belt 14 wound around a roller 12a disposed at one of the most widthwise sides (i.e. the left side in the drawings) among the multiple rollers 12. In this exemplary embodiment, the roller 12a is not a steering roller. The detection sensor 66 is an example of a detector, and the roller 12a is an example of one of the rollers.

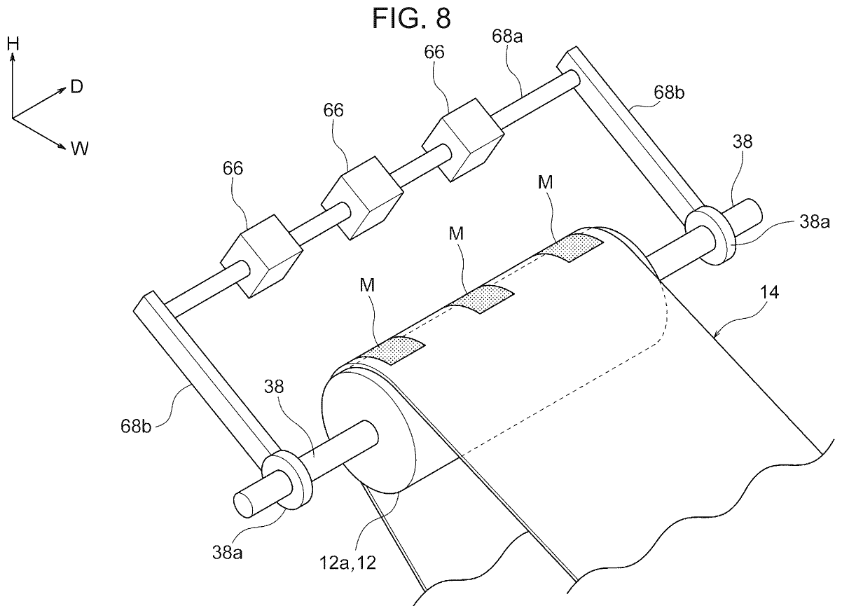

In detail, as shown in FIG. 8, the detection sensor 66 includes three detection sensors arranged in the depth direction. The detection sensors 66 at the opposite ends are disposed to face opposite-end areas of the transfer belt 14, and the detection sensor 66 disposed between the detection sensors 66 at the opposite ends is disposed to face a central area of the transfer belt 14.

A support rod 68a that supports the three detection sensors 66 is provided. The support rod 68a extends in the depth direction. Moreover, ends of attachment rods 68b are attached to opposite ends of the support rod 68a.

In detail, the opposite ends of the roller 12a are provided with shafts 38 of the roller 12a. The shafts 38 are rotatably supported by shaft bearings 38a. One end of each attachment rod 68b is attached to the corresponding shaft bearing 38a, and the other end of the attachment rod 68b is attached to the corresponding end of the support rod 68a. Accordingly, the detection sensors 66 are positioned relative to the roller 12a in the radial direction of the roller 12a via the support rod 68a and the attachment rods 68b.

### Controller 90

The controller 90 controls the rotation of the motor 46 based on, for example, a detection signal of the detection sensor 66. In other words, the distance between the image bearing member 16 and the exposure device 20 is adjusted based on the image density detected by the detection sensor 66.

### Hardware Configuration of Controller 90

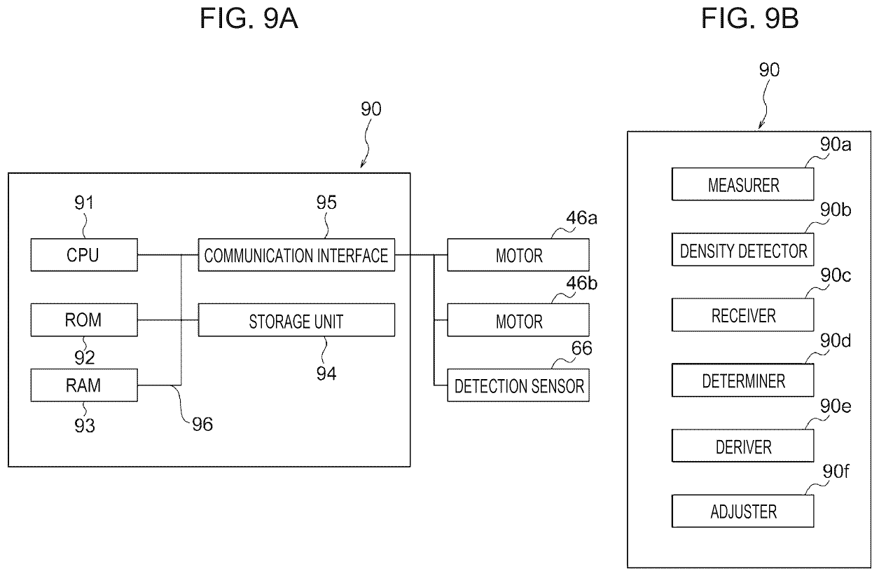

As shown in FIG. 9A, the controller 90 includes a central processing unit (CPU) 91, a read-only memory (ROM) 92, a random access memory (RAM) 93, a storage unit 94, and a communication interface 95. These components are connected in a communicable manner by a bus 96.

The CPU 91 is a central processing unit that executes various types of programs and that controls each unit. Specifically, the CPU 91 loads a program from the ROM 92 or the storage unit 94 and executes the program by using the RAM 93 as a work area. The CPU 91 controls each component and performs various types of arithmetic processing in accordance with the program stored in the ROM 92 or the storage unit 94.

In this exemplary embodiment, for example, the ROM 92 or the storage unit 94 has stored therein a control program that causes the exposure device 20 to move based on the image density detected by the detection sensor 66 so as to cause the image bearing member 16 to be closer toward the focal point of the exposure device 20.

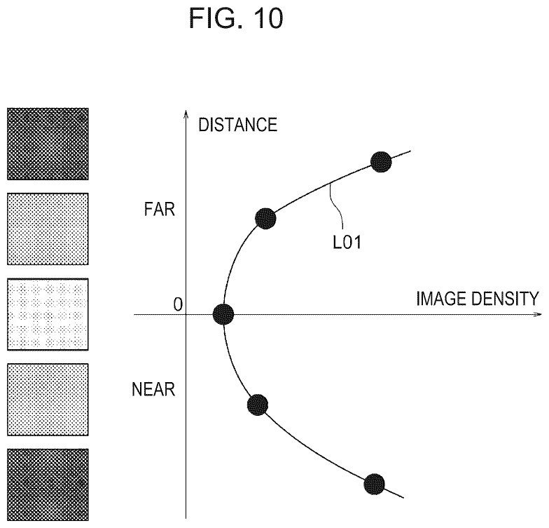

A graph shown in FIG. 10 will now be described. The graph in FIG. 10 indicates the relationship between the distance between the exposure device 20 and the image bearing member 16 and the image density of the toner image. The ordinate axis of the graph indicates the distance between the exposure device 20 and the image bearing member 16, and “0” indicates a state where the image bearing member 16 is disposed at the focal point of the exposure device 20. The upper side relative to “0” indicates the degree by which the image bearing member 16 becomes farther away from the focal point of the exposure device 20, whereas the lower side relative to “0” indicates the degree by which the image bearing member 16 becomes closer toward the focal point of the exposure device 20.

The abscissa axis of the graph indicates the image density of each predetermined patch image, and indicates that the image density decreases toward “0”. It is apparent from this graph that the image density is at minimum when the image bearing member 16 is disposed at the focal point of the exposure device 20. On the other hand, it is apparent that the image density increases as the image bearing member 16 becomes farther away from the focal point of the exposure device 20, and likewise, the image density increases as the image bearing member 16 becomes closer toward the focal point of the exposure device 20.

A variation table indicating image densities of the predetermined patch images are preliminarily stored in the ROM 92 or the storage unit 94. The control program causes the image bearing member 16 to be closer toward the focal point of the exposure device 20 by using this variation table.

The RAM 93 serves as a work area that temporarily stores a program or data. The storage unit 94 is a hard disk drive (HDD) or a solid state drive (SSD), and has stored therein various types of programs, including an operating system, and various types of data.

The communication interface 95 is an interface used by the controller 90 to communicate with, for example, the motor 46a, the motor 46b, and the detection sensor 66, and uses a standard such as Ethernet (registered trademark), fiber distributed data interface (FDDI), or Wi-Fi (registered trademark).

When the operation program described above is to be executed, the controller 90 implements various types of functions by using the hardware resources described above. A functional configuration of the controller 90 for causing the controller 90 to implement the various types of functions will now be described.

### Function Configuration of Controller 90

As shown in FIG. 9B, the controller 90 includes a measurer 90a, a density detector 90b, a receiver 90c, a determiner 90d, a deriver 90e, and an adjuster 90f. Each of these functional units is implemented as a result of the CPU 91 loading the control program stored in the ROM 92 or the storage unit 94 and executing the control program. The control of each unit by the controller 90 will be described below together with the operation.

### Operation

The following description relates to a process for adjusting the distance between the image bearing member 16 and the exposure device 20 when the distance between the image bearing member 16 and the exposure device 20 changes.

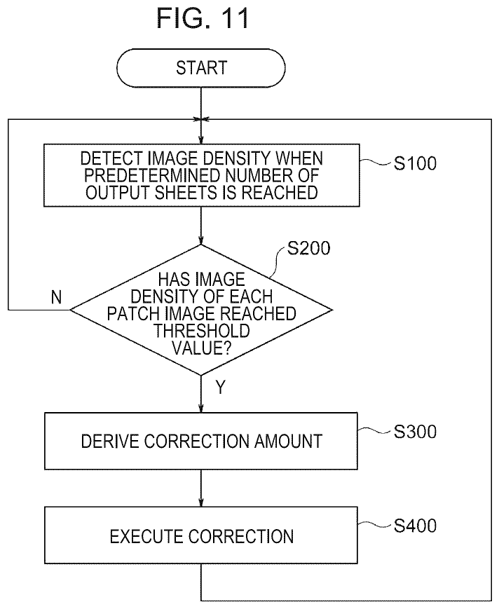

In detail, in a state where the image forming system 10 is delivered to a user, the distance between the image bearing member 16 and the exposure device 20 is within a predetermined range. However, the distance between the image bearing member 16 and the exposure device 20 may change due to, for example, time-related deterioration. In such a case, the image bearing member 16 becomes close to or far away from the focal point of the exposure device 20, thus resulting in lower image quality. Thus, when the distance between the image bearing member 16 and the exposure device 20 changes, a process for adjusting the distance between the image bearing member 16 and the exposure device 20 is performed. The process for adjusting the distance between the image bearing member 16 and the exposure device 20 will now be described with reference to a flowchart in FIG. 11.

First, when the user starts to use the image forming system 10, the measurer 90a of the controller 90 measures the number of sheets output from the image forming system 10. Then, in step S100, when the number of sheets output from the image forming system 10 reaches a predetermined number of output sheets, the image density is detected. A state where the predetermined number of output sheets is reached refers to when, for example, the predetermined number of output sheets is reached and the print job (i.e., a processing unit of printing operation according to a single print command) at the time when the number of output sheets is reached has been completed.

A process for detecting the image density will now be described. In this process, the density detector 90b of the controller 90 commands each image forming unit 28 shown in FIG. 2 to form a predetermined patch image M onto the transfer belt 14. The patch image M is an example of a toner image.

In detail, the density detector 90b gives a command to form patch images M in three areas, namely, the opposite-end areas and the central area of the transfer belt 14. Moreover, the density detector 90b commands the detection sensors 66 shown in FIG. 8 to detect the image densities of the three patch images formed on the revolving transfer belt 14. Then, when the detection sensors 66 detect the image densities of the patch images, the process proceeds to step S200.

In step S200, the receiver 90c of the controller 90 receives the detection result obtained by the detection sensors 66, and the determiner 90d determines whether or not the image density of each of the patch images detected by the detection sensors 66 has reached a predetermined threshold value.

If the image densities of all of the patch images M have not reached the predetermined threshold value, the process returns to step S100. If the image density of any of the patch images M has reached the predetermined threshold value, the process proceeds to step S300. In other words, if the distance between the image bearing member 16 and the exposure device 20 is not within the predetermined range in any of areas (positions), the process proceeds to step S300.

In step S300, the deriver 90e of the controller 90 derives a correction amount for correcting the distance between the image bearing member 16 and the exposure device 20 such that the distance between the image bearing member 16 and the exposure device 20 is within the predetermined range. In other words, the correction amount is derived such that the image bearing member 16 becomes closer toward the focal point of the exposure device 20.

A process for deriving the correction amount will be described in detail below.

The deriver 90e causes the motors 46a and 46b to rotate so as to move the exposure device 20 relative to the image bearing member 16, thereby disposing the exposure device 20 at a first position, a second position, and a third position. At each position, the deriver 90e causes a patch image M to be formed on the transfer belt 14, and causes the corresponding detection sensor 66 to detect the image density of the patch image M.

Furthermore, the receiver 90c receives the image density detected by the detection sensor 66 at each position. Then, the deriver 90e derives the correction amount by comparing the variation table of the image densities of the patch images M and the image densities at the first position, the second position, and the third position. In more detail, by rotating the motors 46a and 46b to actuate the adjustment blocks 44, the correction amount is derived such that the image bearing member 16 becomes closer toward the focal point of the exposure device 20.

In step S400, the adjuster 90f of the controller 90 rotates the motors 46a and 46b based on the correction amount derived by the deriver 90e, so as to move the exposure device 20 toward or away from the image bearing member 16. In other words, the adjuster 90f of the controller 90 executes the correction.

When the above sequential process is completed, the process returns to step S100, and the same process is executed again. The above process is executed for each color.

### Conclusion

As described above, in the image forming system 10, it is determined whether or not the image densities of the patch images M detected by the detection sensors 66 have reached the predetermined threshold value. If any of the image densities of the patch images has reached the predetermined threshold value, the exposure device 20 is moved toward or away from the image bearing member 16 such that the distance between the image bearing member 16 and the exposure device 20 is within the predetermined range. In other words, the distance between the image bearing member 16 and the exposure device 20 is adjusted when the distance between the image bearing member 16 and the exposure device 20 changes.

In the image forming system 10, the distance between the image bearing member 16 and the exposure device 20 is adjusted when the image density of any of the patch images M has reached the predetermined threshold value. Accordingly, the distance may be adjusted at an appropriate timing, as compared with a case where the distance is adjusted when the image densities of all of the patch images M have reached the predetermined threshold value.

In the image forming system 10, the detection sensors 66 detect the image densities of the patch images M in three areas, namely, the opposite-end areas and the central area of the transfer belt 14. Accordingly, a change in distance caused by bending of the exposure device 20 may be detected, as compared with a case where the image densities of the patch images M in the opposite-end areas alone are detected.

In the image forming system 10, the detection sensors 66 detect the image densities of the patch images M in the area of the transfer belt 14 wrapped around the roller 12a. Accordingly, distance variations between the detection sensors 66 and the patch images M may be suppressed, as compared with a case where the image density of each patch image is detected in an area of the transfer belt located between two rollers. Moreover, with the suppressed distance variations between the detection sensors 66 and the patch images M, reduced image-density detection accuracy may be suppressed.

In the image forming system 10, the detection sensors 66 are positioned relative to the roller 12a via the support rod 68a and the attachment rods 68b. Accordingly, distance variations between the detection sensors 66 and the patch images M may be suppressed, as compared with a case where the detection sensors are positioned relative to a frame of the apparatus body.

Although the exemplary embodiment of the present disclosure is described in detail with reference to a specific exemplary embodiment, the exemplary embodiment of the present disclosure is not limited thereto. It is obvious to a skilled person that the present disclosure permits other kinds of exemplary embodiments within the scope of the exemplary embodiments of the present disclosure. For example, as an alternative to the above exemplary embodiment in which the controller 90 uses the adjustment device 48 to adjust the distance between the image bearing member 16 and the exposure device 20, the controller 90 may display an alarm on an operation screen of the image forming system 10 and allow the user or an operator to manually adjust the distance between the image bearing member 16 and the exposure device 20 by using an adjustment device.

As an alternative to the above exemplary embodiment in which the three patch images M are separated from one another in the depth direction, a single patch image may extend in the depth direction (axial direction), so long as the image density of the patch image is detected in each of areas separated from one another in the depth direction.

Although not specifically described in the above exemplary embodiment, a confirmation step for confirming that the image density has not reach the threshold value may be provided after the distance between the image bearing member 16 and the exposure device 20 is corrected in step S400.

As an alternative to the above exemplary embodiment in which the image densities of the patch images M on the transfer belt 14 are detected, the image densities of patch images M on the image bearing member 16 may be detected, or the image densities of patch images formed on the sheet P may be detected.

In the above exemplary embodiment, the image density is at minimum when the image bearing member 16 is disposed at the focal point of the exposure device 20. However, depending on the type of patch image, the image density may be at maximum when the image bearing member 16 is disposed at the focal point of the exposure device 20.

Although not specifically described in the above exemplary embodiment, the image forming system 10 may be constituted of a single apparatus or multiple apparatuses.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) An image forming system comprising:
an image bearing member that rotates;
an exposure device that is disposed facing the image bearing member, has a plurality of lenses arranged in an axial direction of the image bearing member, and exposes the image bearing member to light;
a developing device that develops an electrostatic latent image formed on the image bearing member by the exposure device into a toner image;
a detector that detects an image density of the toner image;
an adjustment device that adjusts a distance between the image bearing member and the exposure device; and
at least one processor configured to:
   cause the adjustment device to adjust the distance when the image density detected by the detector reaches a predetermined threshold value.

(((2))) The image forming system according to (((1))),
wherein the detector detects image densities of the toner image in a plurality of areas in the axial direction, and
wherein the at least one processor is configured to:
   cause the adjustment device to adjust the distance when any of the image densities reaches the predetermined threshold value.

(((3))) The image forming system according to (((2))),
wherein the detector detects the image densities of the toner image in at least opposite-end areas and a central area in the axial direction.

(((4))) The image forming system according to any one of (((1))) to (((3))), further comprising:
a transfer belt that is wrapped around a plurality of rollers and onto which the toner image formed on the image bearing member is transferred,
wherein the detector detects the image density of the toner image in an area of the transfer belt, the area being wrapped around one of the rollers.

(((5))) The image forming system according to (((4))),
wherein the detector is positioned relative to the one of the rollers.

What is claimed is:

1. An image forming system comprising:
an image bearing member that rotates;
an exposure device that is disposed facing the image bearing member, has a plurality of lenses arranged in an axial direction of the image bearing member, and exposes the image bearing member to light;
a developing device that develops an electrostatic latent image formed on the image bearing member by the exposure device into a toner image;
a detector that detects an image density of the toner image;
an adjustment device that adjusts a distance between the image bearing member and the exposure device; and
at least one processor configured to:
cause the adjustment device to adjust the distance when the image density detected by the detector reaches a predetermined threshold value.

2. The image forming system according to claim 1,
wherein the detector detects image densities of the toner image in a plurality of areas in the axial direction, and
wherein the at least one processor is configured to:
cause the adjustment device to adjust the distance when any of the image densities reaches the predetermined threshold value.

3. The image forming system according to claim 2,
wherein the detector detects the image densities of the toner image in at least opposite-end areas and a central area in the axial direction.

4. The image forming system according to claim 1, further comprising:
a transfer belt that is wrapped around a plurality of rollers and onto which the toner image formed on the image bearing member is transferred,
wherein the detector detects the image density of the toner image in an area of the transfer belt, the area being wrapped around one of the rollers.

5. The image forming system according to claim 4,
wherein the detector is positioned relative to the one of the rollers.

6. An image forming system comprising:
an image bearing member that rotates;
an exposure device that is disposed facing the image bearing member, has a plurality of lenses arranged in an axial direction of the image bearing member, and exposes the image bearing member to light;
a developing device that develops an electrostatic latent image formed on the image bearing member by the exposure device into a toner image;
a detector that detects an image density of the toner image;
an adjustment device that adjusts a distance between the image bearing member and the exposure device; and
means for causing the adjustment device to adjust the distance when the image density detected by the detector reaches a predetermined threshold value.
